(19) United States
(12) Patent Application Publication
(10) Pub. No.: US 2026/0248182 A1
(43) Pub. Date: Aug. 27, 2026

(54) AEROSOL GENERATING DEVICE COMPRISING AIR FLOW PATH

(71) Applicant: KT&G CORPORATION, Daejeon (KR)

(72) Inventors: Chul Ho JANG, Gyeonggi-do (KR); Jangwon SEO, Daejeon (KR); Jin Chul JUNG, Daejeon (KR)

(73) Assignee: KT&G CORPORATION, Daejeon (KR)

(21) Appl. No.: 19/159,370

(22) PCT Filed: Sep. 12, 2024
(86) PCT No.: PCT/KR2024/013904

§ 371 Date: Aug. 25, 2025

(30) Foreign Application Priority Data
Oct. 11, 2023 (KR) 10-2023-0134847

(51) Int. Cl. A24F 40/42; A24F 40/10; A24F 40/44; A24F 40/465; A24F 40/485; A24F 40/51; A24F 40/57; A24F 40/60; A24F 40/65

(52) U.S. Cl. CPC A24F 40/42; A24F 40/10; A24F 40/44; A24F 40/465; A24F 40/485; A24F 40/51; A24F 40/57; A24F 40/60; A24F 40/65

(57) ABSTRACT

This aerosol generating device may comprise: a storage tank which stores a liquid aerosol generating material; a wick which receives the aerosol generating material from the storage tank; a vibrator which generates vibrations in the wick to atomize the aerosol generating material; an aerosol flow path through which aerosol generated by the vibrator flows; a mouthpiece which includes an inlet selectively linked to the aerosol flow path and which is hinge-driven with respect to a hinge axis; and an air flow path which opens from the inside of the storage tank in a direction facing the mouthpiece and is opened or closed by a hinge-driven operation of the mouthpiece.

### TECHNICAL FIELD

The following embodiments relate to an aerosol generating device including an air flow channel.

### BACKGROUND ART

These days, the demand for alternative products that overcome the shortcomings of traditional cigarettes is increasing. For example, the demand for devices (e.g., a cigarette-type electronic cigarette) that generate aerosols by electrically heating a cigarette stick or devices that generate aerosols by vaporizing a liquid-type aerosol generating product is increasing. Accordingly, research on electronic aerosol generating devices and aerosol generating products applied thereto is actively being conducted.

The above description is information the inventor(s) acquired during the course of conceiving the present disclosure, or already possessed at the time, and was not necessarily publicly known before the present application was filed.

### DISCLOSURE OF THE INVENTION

### Technical Goals

An aerosol generating device that generates an aerosol from a liquid aerosol generating material may include a reservoir that accommodates the liquid aerosol generating material. As the aerosol generating device is used, the pressure inside the reservoir is relatively lowered, and thus air may flow back through a wick. When air backflow occurs, the movement of the aerosol generating material in the reservoir may be hindered, and the liquid transport efficiency of the reservoir may be reduced.

In order to solve this issue, there has been a technical need to prevent a decrease in air pressure inside a reservoir that accommodates an aerosol generating material and to maintain the inside of the reservoir at atmospheric pressure.

### Technical Solutions

An aerosol generating device according to an embodiment includes a reservoir configured to store an aerosol generating material, a wick configured to receive the aerosol generating material from the reservoir, a vibrator configured to atomize the aerosol generating material by vibrating the wick, an aerosol flow channel through which an aerosol generated in the vibrator flows, a mouthpiece comprising an intake selectively interoperating with the aerosol flow channel and driven by hinge motion based on a hinge axis, and an air flow channel that is opened from an inside of the reservoir in a direction facing the mouthpiece and opened and closed by hinge-driven motion of the mouthpiece.

In an embodiment, the mouthpiece may be driven by hinge motion between a first position at which the aerosol flow channel is disconnected from the intake and a second position at which the aerosol flow channel communicates with the intake.

In an embodiment, the mouthpiece may be configured to close the air flow channel at the first position and open the air flow channel at the second position.

In an embodiment, the aerosol generating device may further include a sealing member configured to seal the air flow channel in a state in which the mouthpiece is in the first position.

In an embodiment, the sealing member may be inserted into an inside of the air flow channel in a state in which the mouthpiece is in the first position.

In an embodiment, the sealing member may be formed of an elastomer such as rubber, silicone, or thermoplastic polyurethane (TPU).

In an embodiment, the aerosol generating device may further include an auxiliary flow channel, wherein one side of the auxiliary flow channel is opened toward the air flow channel and another side that is opposite to the one side communicates with the aerosol flow channel.

In an embodiment, the aerosol generating device may further include an elastic member disposed to enclose the one side of the auxiliary flow channel inside the air flow channel and deforming based on an air pressure change in the auxiliary flow channel.

In an embodiment, the elastic member may deform when air pressure in the auxiliary flow channel is lowered and may be configured to open the air flow channel. In an embodiment, the elastic member may be formed of an elastomer such as rubber, silicone, or TPU.

In an embodiment, the aerosol generating device may further include a leakage prevention member provided inside the air flow channel, wherein at least a partial area of the leakage prevention member is spaced apart from the elastic member when the elastic member deforms as air pressure in the auxiliary flow channel is lowered.

In an embodiment, the reservoir may further include a valve configured to open and close the air flow channel.

In an embodiment, the aerosol generating device may further include a processor configured to control driving of the vibrator and the valve.

In an embodiment, the processor may be configured to open the valve when the driving of the vibrator is initiated.

In an embodiment, the processor may be configured to open the valve when the hinge-driven motion of the mouthpiece is detected.

### Effects of the Invention

An aerosol generating device including an air flow channel according to an embodiment may maintain smooth movement of a liquid aerosol generating material by preventing a pressure drop inside a reservoir and maintaining the pressure at an atmospheric pressure state.

Alternatively, an aerosol generating device including an air flow channel according to an embodiment may open and close the air flow channel based on an usage action of a user (e.g., opening a mouthpiece and/or inhaling through a mouthpiece) and may prevent backflow or leakage of a liquid aerosol generating material.

The effects of the aerosol generating device including an air flow channel according to an embodiment are not limited to the above-mentioned effects, and other unmentioned effects can be clearly understood from the following description by one of ordinary skill in the art.

### BRIEF DESCRIPTION OF DRAWINGS

FIG. 1 is a block diagram of an aerosol generating device according to an embodiment.

FIG. 2 is a diagram schematically illustrating the aerosol generating device according to an embodiment.

FIG. 3A is a perspective view of an aerosol generating device according to an embodiment.

FIG. 3B is a perspective view of the aerosol generating device according to an embodiment.

FIG. 4 is an exploded perspective view of a cartridge according to an embodiment.

FIG. 5A is a cross-sectional view of the aerosol generating device according to an embodiment.

FIG. 5B is an enlarged cross-sectional view of the aerosol generating device according to an embodiment.

FIG. 6A is a cross-sectional view of the aerosol generating device according to an embodiment.

FIG. 6B is an enlarged cross-sectional view of the aerosol generating device according to an embodiment.

FIG. 7 is an enlarged cross-sectional view of the aerosol generating device according to an embodiment.

FIG. 8A is a cross-sectional view of the aerosol generating device according to an embodiment.

FIG. 8B is an enlarged cross-sectional view of the aerosol generating device according to an embodiment.

FIG. 9A is a cross-sectional view of the aerosol generating device according to an embodiment.

FIG. 9B is an enlarged cross-sectional view of the aerosol generating device according to an embodiment.

FIG. 10 is a cross-sectional view of an aerosol generating device according to an embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used to describe the disclosure should be defined based on the meanings of the terms and all the content of the disclosure, rather than the terms themselves.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

As used herein, an expression such as “at least one of” that precedes listed components modifies not each of the listed components but all the listed components. For example, the expression “at least one of a, b, and c” should be construed as including a, b, c, a and b, a and c, b and c, or a, b, and c.

In various embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In various embodiments, the term “upstream” or “upstream direction” may refer to a direction away from a mouth of a user (smoker), and the term “downstream” or “downstream direction” may refer to a direction toward the mouth of the user. The terms “upstream” and “downstream” may be used to describe relative positions of components of the aerosol generating article.

In various embodiments, the term “puff” refers to inhalation by a user, and inhalation refers to a situation in which a user draws in an aerosol into his or her oral cavity, nasal cavity, or lungs through the mouth or nose.

In an embodiment, an aerosol generating device may be a device that generates an aerosol by electrically heating a cigarette accommodated in an inner space.

In an embodiment, the aerosol generating device may include a heater. In an embodiment, the heater may be an electrically resistive heater. For example, the heater may include an electrically conductive track, and the heater may be heated as a current flows through the electrically conductive track.

In an embodiment, the heater may include a tubular heating element, a plate-shaped heating element, a needle-shaped heating element, or a rod-shaped heating element and may heat the inside or outside of the cigarette according to the shape of a heating element.

In an embodiment, the cigarette may include a tobacco rod and a filter rod. The tobacco rod may be formed as a sheet or a strand, or may be formed of tobacco leaves finely cut from a tobacco sheet. In addition, the tobacco rod may be enveloped by a thermally conductive material. For example, the thermally conductive material may be metal foil such as aluminum foil. However, embodiments are not limited thereto.

In an embodiment, the filter rod may be a cellulose acetate filter. The filter rod may include at least one segment. For example, the filter rod may include a first segment that cools an aerosol and a second segment that filters a predetermined ingredient contained in the aerosol.

In an embodiment, the aerosol generating device may be a device that generates an aerosol using a cartridge containing an aerosol generating material.

In an embodiment, the aerosol generating device may include a cartridge containing the aerosol generating material and a main body supporting the cartridge. The cartridge may be detachably coupled to the main body. However, embodiments are not limited thereto. The cartridge may be integrally formed or assembled with the main body and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

In an embodiment, the cartridge may hold the aerosol generating material having any one of various states, such as a liquid state, a solid state, a gaseous state, and a gel state. The aerosol generating material may include a liquid composition. For example, the liquid composition may be a liquid including a tobacco-containing material having a volatile tobacco flavor component or may be a liquid including a non-tobacco material.

In an embodiment, the cartridge may be operated by an electrical signal or a wireless signal transmitted from the main body to perform the function of generating an aerosol by converting the phase of the aerosol generating material inside the cartridge to a gaseous phase. The aerosol may refer to a gas in which vaporized particles generated from the aerosol generating material are mixed with air.

In various embodiments, the aerosol generating device may generate an aerosol by heating the liquid composition, and the generated aerosol may pass through the cigarette and be transferred to the user. That is, the aerosol generated from the liquid composition may travel along an airflow path of the aerosol generating device, and the airflow path may be configured to allow the aerosol to pass through the cigarette and be transferred to the user.

In various embodiments, the aerosol generating device may be a device that generates an aerosol from the aerosol generating material using an ultrasonic vibration technique In this case, the ultrasonic vibration technique may be a technique of generating an aerosol by atomizing the aerosol generating material with ultrasonic vibration generated by a vibrator.

In an embodiment, the aerosol generating device may include a vibrator, and may generate vibration at short intervals through the vibrator to atomize the aerosol generating material. The vibration generated by the vibrator may be ultrasonic vibration, and a frequency band of the ultrasonic vibration may be from about 100 kilohertz (kHz) to about 3.5 megahertz (MHz). However, embodiments are not limited thereto.

In an embodiment, the aerosol generating device may further include a wick that absorbs the aerosol generating material. For example, the wick may be disposed to enclose at least one area of the vibrator or may be disposed to be in contact with at least one area of the vibrator.

In an embodiment, as a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, the viscosity of the aerosol generating material absorbed in the wick may be lowered by the heat generated by the vibrator, and the aerosol generating material with lowered viscosity may be changed to fine particles by the ultrasonic vibration generated by the vibrator, so that an aerosol may be generated. However, embodiments are not limited thereto.

In various embodiments, the aerosol generating device may be a device that generates an aerosol by heating the aerosol generating article accommodated therein in an induction heating manner.

In an embodiment, the aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, selectively, the susceptor may be positioned in the aerosol generating article.

In various embodiments, the aerosol generating device may further include a cradle.

In an embodiment, the aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

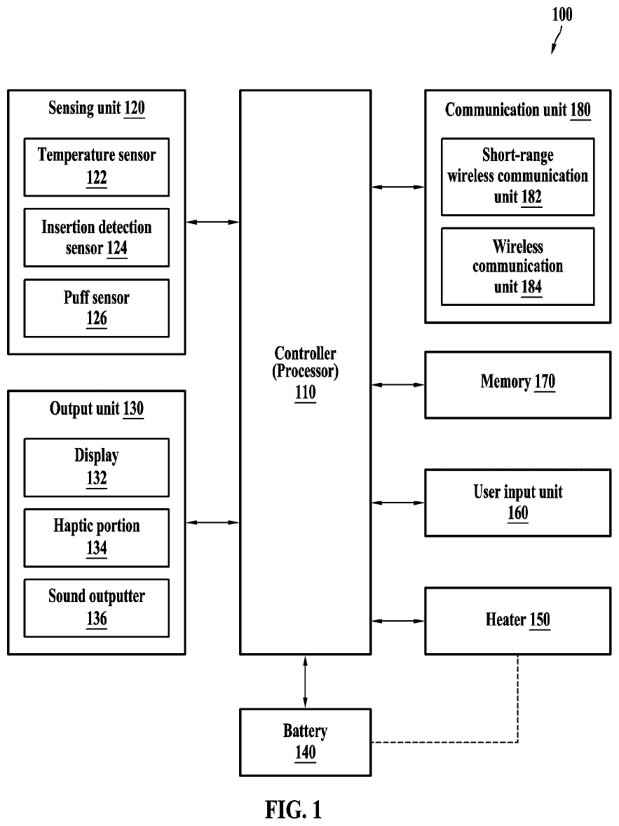

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

In an embodiment, the sensing unit 120 may sense a state of the aerosol generating device 100 or a state of an environment around the aerosol generating device 100 and transmit sensed information to the controller 110. Based on the sensed information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

In an embodiment, the sensing unit 120 may include at least one of a temperature sensor 122, an insertion detection sensor 124, and a puff sensor 126. However, embodiments are not limited thereto.

In an embodiment, the temperature sensor 122 may sense a temperature at which the heater 150 (or an aerosol generating material) is heated. The aerosol generating device 100 may include a separate temperature sensor for sensing the temperature of the heater 150, or the heater 150 itself may also function as a temperature sensor. Alternatively, the temperature sensor 122 may be disposed around the battery 140 to monitor the temperature of the battery 140.

In an embodiment, the insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, and an infrared sensor, which may sense a signal change by the insertion and/or removal of the aerosol generating article.

In an embodiment, the puff sensor 126 may sense a puff from a user based on various physical changes in an airflow path or airflow channel. For example, the puff sensor 126 may sense the puff from the user based on any one of a temperature change, a flow change, a voltage change, and a pressure change.

In an embodiment, the sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 through 126 described above. A function of each sensor may be intuitively inferable from its name by one of ordinary skill in the art, and thus, a more detailed description thereof will be omitted here.

In an embodiment, the output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

In an embodiment, the display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

In an embodiment, the haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

In an embodiment, the sound outputter 136 may provide information about the aerosol generating device 100 to the user in an auditory way. For example, the sound outputter 136 may convert an electrical signal into a sound signal and externally output the sound signal.

In an embodiment, the battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

In an embodiment, the heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol by induction heating, the aerosol generating device 100 may further include a DC-to-alternating current (AC) (DC/AC) converter that converts DC power of the battery 140 into AC power.

In an embodiment, the controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a suitable predetermined electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like. However, embodiments are not limited thereto.

According to an embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating an aerosol generating article and a second heater for heating a liquid.

In an embodiment, the user input unit 160 may receive information input from the user or may output information to the user. For example, the user input unit 160 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface, and may be connected to another external device through the connection interface such as a USB interface to transmit and receive information or to charge the battery 140.

In an embodiment, the memory 170, which is hardware for storing various pieces of data processed in the aerosol generating device 100, may store data processed by the controller 110 and data to be processed by the controller 110. The memory 170 may include at least one type of storage medium of flash memory-type memory, hard disk-type memory, multimedia card micro-type memory, card-type memory (e.g., secure digital (SD) or extreme digital (xD) memory), random access memory (RAM), static RAM (SRAM), read-only memory (ROM), electrically erasable programmable ROM (EEPROM), programmable ROM (PROM), magnetic memory, a magnetic disk, or an optical disk. The memory 170 may store an operating time of the aerosol generating device 100, a maximum number of puffs, a current number of puffs, at least one temperature profile, data associated with a smoking pattern of the user, or the like.

In an embodiment, the communication unit 180 may include at least one component for communicating with another electronic device. For example, the communication unit 180 may include a short-range wireless communication unit 182 and a wireless communication unit 184.

In an embodiment, the short-range wireless communication unit 182 may include a Bluetooth communication unit, a BLE communication unit, a near field communication unit, a wireless local area network (WLAN) communication unit (e.g., wireless fidelity (Wi-Fi)), a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

In an embodiment, the wireless communication unit 184 may include, for example, a cellular network communicator, an Internet communicator, a computer network (e.g., a LAN or a wide-area network (WAN)) communicator, or the like. However, embodiments are not limited thereto. The wireless communication unit 184 may use subscriber information (e.g., international mobile subscriber identity (IMSI)) to identify and authenticate the aerosol generating device 100 in a communication network.

In an embodiment, the controller 110 may control the overall operation of the aerosol generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that the processor may be implemented in other types of hardware.

In an embodiment, the controller 110 may control the temperature of the heater 150 by controlling supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

In an embodiment, the controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. As another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

In an embodiment, the controller 110 may control the output unit 130 based on the sensing result obtained by the sensing unit 120. For example, when the number of puffs counted through the puff sensor 126 reaches a preset number, the controller 110 may inform the user that the aerosol generating device 100 is to be ended soon, through at least one of the display 132, the haptic portion 134, or the sound outputter 136.

In an embodiment, the controller 110 may control a power supply time and/or a power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that can be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

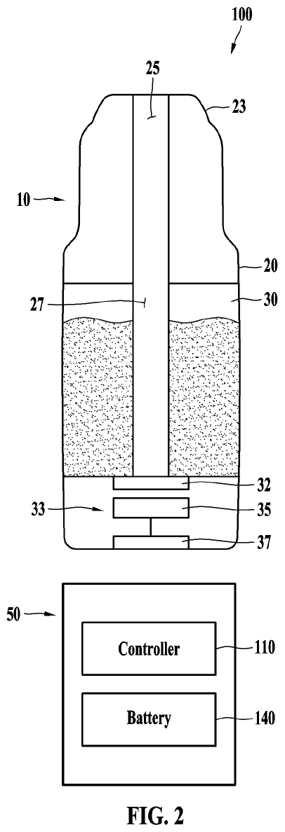

FIG. 2 is a diagram schematically illustrating the aerosol generating device 100 according to an embodiment.

Referring to FIG. 2, the aerosol generating device 100 according to an embodiment may include a cartridge 10 and a main body 50. Some components of the aerosol generating device 100 described below with reference to FIG. 2 may be substantially the same as or similar to some components of the aerosol generating device 100 described above with reference to FIG. 1, and a duplicate description will be omitted below.

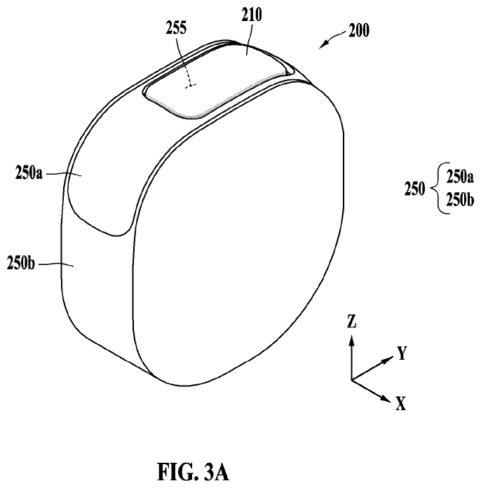

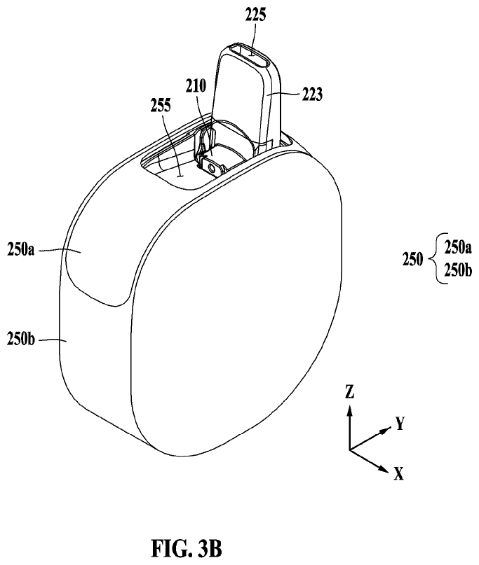

In an embodiment, the cartridge 10 may accommodate an aerosol generating material and may be detachably fastened to the main body 50. For example, at least a portion of the cartridge 10 may be inserted into the main body 50 (e.g., a cartridge 10 fastening area of FIG. 3A), whereby the cartridge 10 and the main body 50 may be connected. Embodiments are not limited thereto, and at least a portion of the main body 50 may be inserted into the cartridge 10, whereby the cartridge 10 and the main body 50 may be connected. The cartridge 10 and the main body 50 may be fastened to each other in various ways, such as screw fastening, magnetic fastening, fit fastening, or snag-fit fastening.

In an embodiment, the cartridge 10 may include at least a portion of a reservoir 30, a transmission member 32, and a vibrator assembly 33 and may include a housing 20 for accommodating these components therein.

In an embodiment, the housing 20 may form the exterior of the cartridge 10 and may accommodate at least a portion of the component for driving the aerosol generating device 100 therein.

In an embodiment, the structure and shape of the housing 20 may be implemented in various manners, and for example, as shown in FIG. 2, the housing 20 may be formed in the shape of a column or stick, but embodiments are not limited thereto. The housing 20 may include a mouthpiece 23 and an aerosol flow channel 27.

In an embodiment, the mouthpiece 23 may be directly or indirectly connected to a body of a user of the aerosol generating device 100. The mouthpiece 23 may include an intake 25 communicating with the inside of the cartridge 10, specifically, the aerosol flow channel 27.

For example, the user may inhale an aerosol generated by the aerosol generating device 100 by bringing the mouth into contact with the mouthpiece 23. When the user inhales through the mouthpiece 23, the pressure in the intake 25 and the aerosol flow channel 27 may decrease, and the aerosol inside the cartridge 10 may pass through the aerosol flow channel 27 and the intake 25 and be transferred to the user.

In an embodiment, the reservoir 30 may be positioned in the inner space of the housing 20 to accommodate the aerosol generating material. For example, the reservoir 30 may accommodate and store the aerosol generating material and may provide the aerosol generating material to another component (e.g., the transmission member 32) or be supplied with the aerosol generating material from the outside.

In an embodiment, the aerosol generating material may be a material in various phases such as liquid, solid, gas, or gel, or may be a material in a mixed phase thereof.

In an embodiment, the aerosol generating material may be a liquid including a volatile tobacco flavor ingredient and a tobacco-containing material. For example, the aerosol generating material may include at least a portion of water, a solvent, ethanol, a plant extract, a fragrance, a flavoring agent, and a vitamin mixture. Alternatively, the aerosol generating material may include at least a portion of menthol, peppermint, spearmint oil, and fruit flavor.

In an embodiment, the transmission member 32 may receive the aerosol generating material from the reservoir 30. The transmission member 32 may be directly or indirectly connected to the reservoir 30, and at least a partial area thereof may face the aerosol flow channel 27. The transmission member 32 may include at least a portion of cotton, ceramic, glass, and a porous material or may structurally include a flow channel through which the aerosol generating material flows. For example, the transmission member 32 may be a wick formed of a hygroscopic or porous material.

In an embodiment, the vibrator assembly 33 may be positioned inside the housing 20 and vibrate the transmission member 32. The vibrator assembly 33 may include a vibrator 35 and a cartridge substrate 37 for controlling the driving of the vibrator 35.

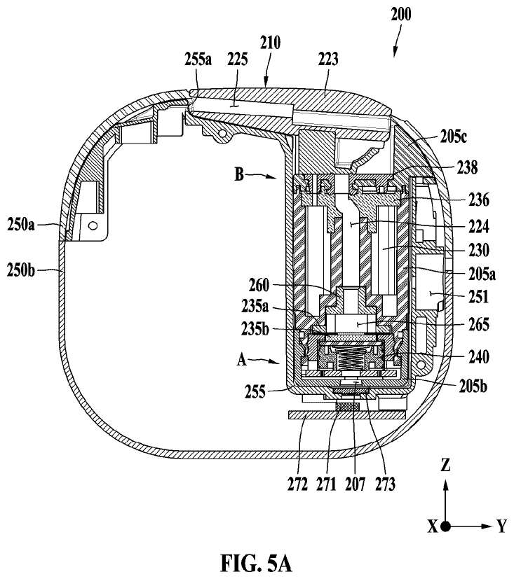

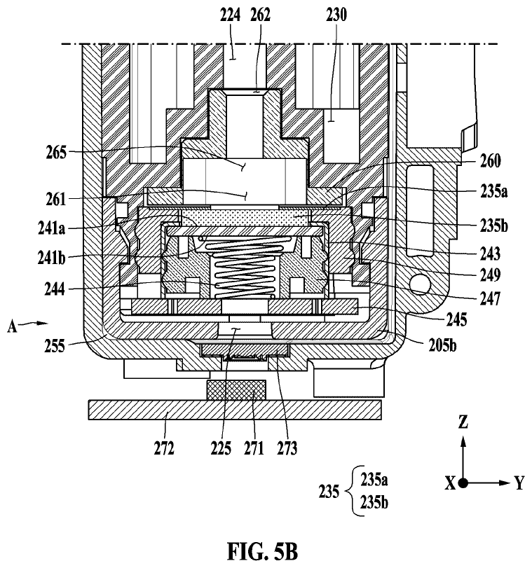

For example, the vibrator assembly 33 or the vibrator assembly 33 and other components (e.g., a partial area of the housing 20 and/or the transmission member 32) may form an atomizer. A detailed structure of the vibrator assembly 33 according to an embodiment will be described below with reference to FIG. 5A.

In an embodiment, the vibrator assembly 33 may generate vibration at relatively short intervals or may generate ultrasonic vibration. For example, the frequency of ultrasonic vibration may be about 100 kHz to 3.5 MHz. The aerosol generating material transmitted from the reservoir 30 to the transmission member 32 by the vibration of the vibrator assembly 33 may be vaporized and/or change into particles to be atomized into an aerosol.

In an embodiment, the main body 50 may accommodate a controller (e.g., the controller 110 of FIG. 1) for controlling the driving of the aerosol generating device 100, a battery (e.g., the battery of FIG. 1), and other components (e.g., at least a portion of the sensing unit 120, the output unit 130, the memory 170, and the communication unit 180 of FIG. 1).

In an embodiment, the main body 50 may be electrically or communicatively connected to the cartridge substrate 37 to supply data and/or power thereto. Although FIG. 2 illustrates the controller 110 and the cartridge substrate 37 separately as an example, embodiments are not limited thereto. For example, the cartridge substrate 37 may be included as part of the controller 110, and the main body 50 may further include a main body substrate (e.g., a main body substrate 272 of FIG. 5A), which is another component of the controller 110.

FIG. 3A is a perspective view of an aerosol generating device 200 according to an embodiment, and FIG. 3B is a perspective view of the aerosol generating device 200 according to an embodiment. Specifically, FIG. 3A shows a closed state of a mouthpiece 223 of the aerosol generating device 200, and FIG. 3B shows an open state of the mouthpiece 223 of the aerosol generating device 200.

Referring to FIGS. 3A and 3B, the aerosol generating device 200 (e.g., the aerosol generating device 100 of FIG. 1 or 2) according to an embodiment may include at least a portion of a cartridge 210 (e.g., the cartridge 10 of FIG. 2) and a main body 250 (e.g., the main body 50 of FIG. 2).

In an embodiment, the aerosol generating device 200 and the components thereof shown in FIG. 3A are one of the implementable examples of the aerosol generating device 200 described above with reference to FIGS. 1 and 2 but are not limited thereto in practical implementation, and the aerosol generating device 200 may be implemented in various structures and shapes. Hereinafter, in describing the aerosol generating device 200, the description provided above will not be repeated.

In an embodiment, the main body 250 may include a first body 250a and a second body 250b. The first body 250a and the second body 250b may be secured and fastened to each other, and each of the first body 250a and the second body 250b may accommodate and protect the internal components of the aerosol generating device 200.

In an embodiment, the first body 250a may include a cartridge fastening area 255 and may support the cartridge 210 when the cartridge 210 is fastened to the cartridge fastening area 255. For example, the cartridge fastening area 255 may be formed open on a surface of the first body 250a in one direction (e.g., +z direction), and the cartridge 210 may be fastened thereto in a manner of being inserted into the cartridge fastening area 255.

In an embodiment, the second body 250b may be fastened to the first body 250a and may be an area for a user to grip the aerosol generating device 200. Although not shown in the drawing, at least some of a temperature sensor (e.g., the temperature sensor 122 of FIG. 1) and a substrate (e.g., the controller 110 of FIG. 1 or 2) may be accommodated inside the second body 250b. In the drawings, the second body 250b is shown as having a substantially circular or polygonal shape, but is not limited thereto in practical implementation, and may be implemented in the shape of a column or stick, for example.

In an embodiment, the cartridge 210 may include the mouthpiece 223. The mouthpiece 223 may be rotated or tilted based on a rotation axis, and based on the rotation or tilting, an intake 225 (e.g., the intake 25 of FIG. 2) of the mouthpiece 223 may be selectively exposed.

For example, as shown in FIG. 3A, when the aerosol generating device 200 is not in use by the user or is being stored, the mouthpiece 223 may be positioned inside the cartridge fastening area 255, and the intake 225 may not be exposed to the outside of the aerosol generating device 200.

For example, as shown in FIG. 3B, the user may rotate or tilt the mouthpiece 223 to use the aerosol generating device 200, and the intake 225 may be exposed to the outside of the aerosol generating device 200.

As shown in FIGS. 3A and 3B, the aerosol generating device 200 may cover the intake 225 as necessary, so that the aerosol generating device 200 may prevent an external foreign substance from entering the cartridge 210 through the intake 225, and prevent the intake 225 from being contaminated. Alternatively, the aerosol generating device 200 may cover the intake 225, thereby preventing a portion of the aerosol or aerosol generating material from leaking from the cartridge 210 to the outside of the aerosol generating device 200.

However, the method of driving the mouthpiece 223 of FIGS. 3A and 3B is merely an example, and is not limited thereto in practical implementation, and may be implemented in various manners. For example, the main body 250 or the cartridge 210 may include a separate door to selectively expose the intake 225 of the cartridge 210.

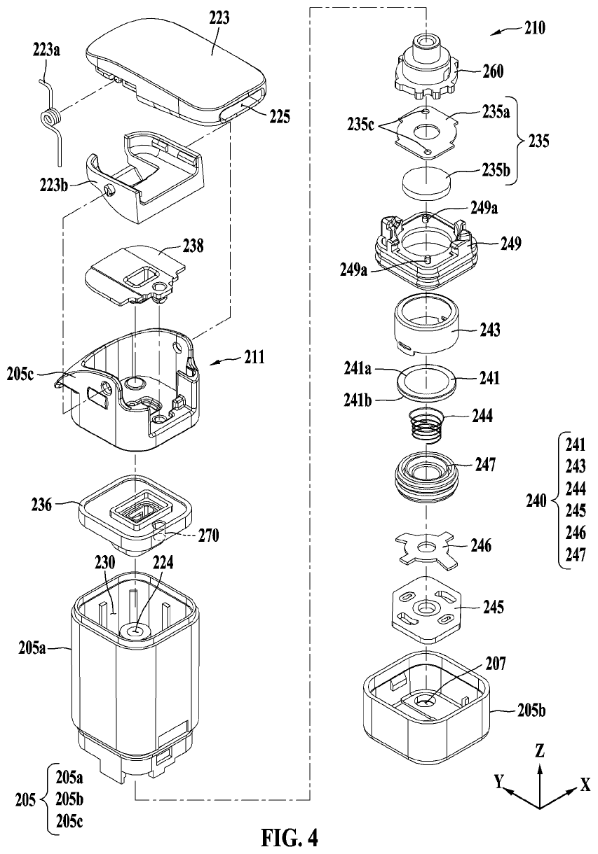

FIG. 4 is an exploded perspective view of the cartridge 210 according to an embodiment.

Referring to FIG. 4, in an embodiment, the cartridge 210 may include a cartridge body 211 and the mouthpiece 223.

In an embodiment, the cartridge body 211 may include at least a portion of a housing 205, a wick 235, and a vibrator assembly 240.

In an embodiment, the mouthpiece 223 may be coupled or connected to the cartridge body 211 so as to move with respect to the cartridge body 211. The components of the cartridge 210 according to an embodiment are not limited to the example described above, and components may be added, or a portion of the components may be omitted according to embodiments.

In an embodiment, the housing 205 may form the overall exterior of the cartridge 210, while forming an inner space for accommodating the components of the cartridge 210 (e.g., at least a portion of a reservoir 230, the wick 235, and the vibrator assembly 240) therein.

In an embodiment, the structure and shape of the housing 205 may be implemented in various manners. For example, the housing 205 may be formed in the shape of a column or stick, but is not limited thereto. Although only the embodiment of the housing 205 of the cartridge 210 having an overall rectangular column shape is shown in the drawing, in another embodiment (not shown), the housing 205 may be formed in an overall cylindrical column or another polygonal column (e.g., a triangular pillar or a pentagonal pillar) other than the rectangular column.

In an embodiment, the housing 205 may include a first housing 205a, a second housing 205b connected to one area of the first housing 205a, and a third housing 205b connected to another area of the first housing 205a.

For example, the second housing 205b may be coupled to one area positioned at a lower end (e.g., −z direction) of the first housing 205a, and an inner space may be formed between the first housing 205a and the second housing 205 so that the components of the cartridge 210 may be disposed therein.

In an embodiment, the third housing 205c may be coupled to one area positioned at an upper end (e.g., +z direction) of the first housing 205a, and at least a portion of the mouthpiece 223 may be disposed on one side of the third housing 205c.

In an embodiment, the first housing 205a and the second housing 205b may be coupled to each other to form an aerosol flow channel 224 through which an airflow (e.g., air or an aerosol) moves inside the cartridge body 211. For example, the first housing 205a may form a portion of the aerosol flow channel 224, and the second housing 205b may form the remaining portion of the aerosol flow channel 224.

In an embodiment, the first housing 205a and the second housing 205b may be coupled to form an inner space, and various components necessary for the operation of the cartridge 210, such as the vibrator assembly 240 and the wick 235, may be accommodated or disposed in the inner space.

In an embodiment, the first housing 205a and the second housing 205b may protect the components accommodated in the inner space, and the third housing 205c may protect the mouthpiece 223 and other components coupled or connected to the mouthpiece 223. The housing 205 may form at least a portion of the aerosol flow channel 224, or at least a portion of the structure of the housing 205 may function as an inner wall of the aerosol flow channel 224.

In an embodiment, the housing 205 may include a sensor hole 207. The sensor hole 207 may be formed in a partial area of the second housing 205b of the housing 205. For example, the sensor hole 207 may be positioned in a bottom surface of the second housing 205b where the cartridge 210 is coupled to the main body 250. The sensor hole 207 may be formed at a position opposite to a temperature sensor (e.g., a temperature sensor 271 of FIG. 5A). The sensor hole 207 will be described with reference to FIG. 5A and so on.

In an embodiment, the mouthpiece 223 may be a portion that contacts the mouth of the user, and the mouthpiece 223 may be disposed in or coupled to one area of the housing 205. For example, the mouthpiece 223 may be connected to the third housing 205c.

In an embodiment, the mouthpiece 223 may move between an open position and a closed position. The cartridge 210 may further include an elastic body 223a for providing an elastic force to the mouthpiece 223. For example, the elastic body 223a may elastically support the mouthpiece 223 toward the open position.

In an embodiment, the elastic body 223a may be disposed on or around the axis of rotation of the mouthpiece 223. The mouthpiece 223 may move from the closed position to the open position by the elastic force of the elastic body 223a. The elastic body 223a may be manufactured using a metal material (e.g., steel use stainless (SUS)). In an embodiment, the mouthpiece 223 may rotate around a rotation axis, and the elastic body 223a may be a torsion spring positioned on the rotation axis of the mouthpiece 223. The elastic body 223a may relatively greatly deform when the mouthpiece 223 is in the closed position, and relatively less deform when the mouthpiece 223 is in the open position. Accordingly, the mouthpiece 223 may be provided with a biased elastic force to open from the closed position to the open position.

In an embodiment, the mouthpiece 223 may include the intake 225 for discharging the aerosol generated inside the cartridge 210 to the outside of the cartridge 210. For example, one side of the intake 225 may be connected to the outside, and the other side thereof may be connected to the aerosol flow channel 224 in the open position. The user may bring the mouth into contact with the mouthpiece 223 and be supplied with the aerosol discharged to the outside through the intake 225 of the mouthpiece 223.

In an embodiment, the mouthpiece 223 may be rotatably or tiltably coupled to the third housing 205c together with a support portion 223b. The support portion 223b may be disposed between the mouthpiece 223 and the third housing 205c and surround at least a portion of the other side of the mouthpiece 223.

In an embodiment, the mouthpiece 223, the support portion 223b, and the third housing 205c may be connected to one another by the rotation axis. Accordingly, the mouthpiece 223 may be firmly coupled to the third housing 205c and may rotate with respect to the third housing 205c to move between the open position and the closed position.

In an embodiment, the aerosol atomized by the vibrator assembly 240 may be discharged to the outside of the cartridge 210 through the aerosol flow channel 224 and supplied to the user. For example, the aerosol generated by a vibrator (e.g., the vibrator 241 of FIG. 5B) of the vibrator assembly 240 may flow along the aerosol flow channel 224, which is formed to connect an atomization space (e.g., an atomization space 265 of FIG. 5A) and the intake 225 of the mouthpiece 223 or communicate therewith, and then be discharged to the outside of the cartridge 210 through the intake 225.

In an embodiment, the aerosol flow channel 224 may be connected to the mouthpiece 223 along the internal structure of the second housing 205b and the first housing 205a. For example, the airflow moving in a forward direction along the aerosol flow channel 224 may move sequentially in predetermined directions (e.g., sequentially in +z direction, a direction transverse to the z-axis, −z direction, the direction transverse to the z-axis, and +z direction).

In an embodiment, the intake 225 may be a passage inside of the mouthpiece 223. The intake 225 may be connected to the aerosol flow channel 224 when the mouthpiece 223 is in the open position. The intake 225 may be disconnected from the aerosol flow channel 224 when the mouthpiece 223 is in the closed position.

In an embodiment, the reservoir 230 may be disposed inside the first housing 205a, and an aerosol generating material may be stored in the reservoir 230. For example, a liquid aerosol generating material may be stored in the reservoir 230. However, embodiments are not limited thereto.

In an embodiment, the wick 235 may be positioned between the reservoir 230 and the vibrator 241 of the vibrator assembly 240. The wick 235 may include a transmission member 235a and an absorber 235b.

In an embodiment, the transmission member 235a may contact a reinforcing member 260, and the absorber 235b may be provided between the transmission member 235a and the vibrator 241. The transmission member 235a may include a reinforcing member 260 and a wick hole, for example, communicating with an opening of the reinforcing member 260, and the absorber 235b may be disposed to face the atomization space 265 through the wick hole.

In an embodiment, the aerosol generating material stored in the reservoir 230 may be supplied to the vibrator assembly 240 through the transmission member 235a. The transmission member 235a may receive the aerosol generating material from the reservoir 230 and transmit the received aerosol generating material to the vibrator 241 or the absorber 235b, or the transmission member 235a may serve to atomize the aerosol generating material in response to receiving ultrasonic vibration from the vibrator 241. For example, the transmission member 235a may absorb the aerosol generating material in the reservoir 230, and the aerosol generating material absorbed in the transmission member 235a may be transmitted to the vibrator assembly 240.

In an embodiment, the cartridge 210 may include the absorber 235b that transmits the absorbed aerosol generating material to the vibrator assembly 240. The absorber 235b may be disposed to cover at least a portion of the vibrator 241 of the vibrator assembly 240 where an aerosol is generated, and may receive the aerosol generating material from the transmission member 235a and absorb and atomize at least a portion of the aerosol generating material.

In an embodiment, the absorber 235b may be manufactured using a material capable of absorbing an aerosol generating material. For example, the absorber 235b may include at least one material of SPL 30(H), SPL 50(H)V, NP 100(V 8), SPL 60(FC), and melamine.

In an embodiment, as the cartridge 210 includes the absorber 235b, the aerosol generating material may be absorbed not only in the transmission member 235a but also in the absorber 235b, so that the amount of aerosol generating material being absorbed may improve.

In an embodiment, the transmission member 235a may include a material that has a higher absorption rate of aerosol generating material than the absorber 235b. For example, when the transmission member 235a has a higher absorption rate than the absorber 235b, the aerosol generating material transmitted to the absorber 235b by the transmission member 235a may be controlled to be supplied at a uniform rate to the vibrator 241 by the absorber 235b having a relatively low absorption rate. Accordingly, contact of an excessively large amount of aerosol generating material with the vibrator 241 may be prevented.

In an embodiment, as the absorber 235b is disposed to cover at least a portion of the vibrator 241, the absorber 235b may function as a physical barrier to prevent “spitting” of particles that are not sufficiently atomized during the aerosol generating process from being discharged directly to the outside of the aerosol generating device 200. Here, “spitting” may indicate that particles of an aerosol generating material having relatively large sizes as not sufficiently atomized are discharged to the outside of the cartridge 210. As the cartridge 210 further includes the absorber 235b, the possibility of spitting may be reduced, and the smoking satisfaction of the user may improve.

In an embodiment, the absorber 235b may be positioned between one surface of the vibrator 241 where an aerosol is generated and the transmission member 235a, and transmit the aerosol supplied to the transmission member 235a to the vibrator 241.

For example, one area of the absorber 235b may contact one area of the transmission member 235a facing one direction (e.g., −z direction), and another area of the absorber 235b may contact one area of the vibrator 241 of the vibrator assembly 240 facing one direction (e.g., +z direction). That is, the absorber 235b may be positioned on an upper end surface (e.g., a surface in the +z direction or a first surface 241a of FIG. 5B) of the vibrator 241, and transmit the aerosol generating material absorbed by the transmission member 235a to the vibrator assembly 240.

In an embodiment, the transmission member 235a, the absorber 235b, and the vibrator assembly 240 may be sequentially disposed in the longitudinal direction (e.g., z-axis direction) of the cartridge 210 or the housing 205, and the absorber 235b and the transmission member 235a may be sequentially stacked on the vibrator 241.

At least a portion of the aerosol generating material supplied from the reservoir 230 to the transmission member 235a through the above-described arrangement structure may move to the absorber 235b contacting the transmission member 235a, and the aerosol generating material having moved to the absorber 235b may move along the absorber 235b and reach an area adjacent to the vibrator assembly 240.

In an embodiment, the aerosol generating material may be stably transmitted to the vibrator assembly 240, such that the vibrator assembly 240 may continuously generate a uniform amount of aerosol, and the arrangement structure described above may implement a physical dual barrier that prevents the above-described spitting by the transmission member 235a and the absorber 235b.

In an embodiment, although the drawings show only an embodiment in which the cartridge 210 includes one transmission member 235a and one absorber 235b, the cartridge 210 according to another embodiment may include two or more of at least one of the transmission member 235 and the absorber 235b, or the transmission member 235a and the absorber 235b may be implemented as one body.

For example, the absorber 235b may be a separate component of the cartridge 210 connected to the transmission member 235a, or the transmission member 235a and the absorber 235b may be components mutually connected or coupled or an integral component, but embodiments are not limited thereto.

In an embodiment, the cartridge 210 may further include a support plate 246 for grounding a cartridge substrate 245 or firmly coupling the cartridge substrate 245 to the second housing 205b.

The vibrator assembly 240 according to an embodiment may include at least a portion of the vibrator 241, a first electrode body 243, a second electrode body 244, a support structure 247, the support plate 246, and the cartridge substrate 245.

In an embodiment, the vibrator assembly 240 may atomize the aerosol generating material by vibrating the transmission member 235a.

In an embodiment, the vibrator 241 may generate an aerosol by atomizing the liquid aerosol generating material by vibrating the transmission member 235a. The vibrator 241 may include the first surface 241a facing the transmission member 235a, and a second surface 241b opposite to the first surface 241a.

In an embodiment, the vibrator 241 may include a piezoelectric ceramic. The piezoelectric ceramic may be a functional material that generates electricity when applied with force and generates force when applied with electricity, thereby converting electricity and force to each other. For example, the vibrator 241 may generate vibration at short intervals by the applied electricity, and the vibration may vaporize the aerosol generating material and/or change the aerosol generating material into particles.

In an embodiment, the vibrator 241 may generate ultrasonic vibration. The frequency of the ultrasonic vibration generated by the vibrator 241 may be about 100 kHz to 10 MHz, and preferably about 100 kHz to 3.5 MHz.

In an embodiment, as the vibrator 241 generates ultrasonic vibration of a corresponding frequency band, the vibrator 241 may vibrate in the longitudinal direction (e.g., z-axis direction) of the cartridge 210 or the housing 205. However, the direction in which the vibrator 241 according to an embodiment of the present disclosure vibrates is not limited thereto, and the direction in which the vibrator vibrates may be changed to various directions (e.g., one of the x-axis direction, the y-axis direction, and the z-axis direction or a combination thereof).

In an embodiment, the vibrator 241 may atomize the aerosol generating material in an ultrasonic manner, thereby generating an aerosol at a relatively low temperature compared to a manner of heating the aerosol generating material. For example, in the manner of heating the aerosol generating material using a heater, the aerosol generating material may be unintentionally heated to a temperature of 200 degrees Celsius or higher, and the user may feel a burnt taste in the aerosol.

In an embodiment of the present disclosure, the cartridge 210 may atomize the aerosol generating material in an ultrasonic manner, thereby generating an aerosol in the temperature range of about 100 to 160 degrees Celsius, which is a relatively low temperature compared to the manner of heating the aerosol generating material using a heater. Accordingly, the degree to which the user perceives a burnt taste from the aerosol may be reduced, and the smoking satisfaction of the user may be improved.

In an embodiment, the vibrator 241 may be electrically connected to an external power source through the cartridge substrate 245, and may generate ultrasonic vibration by the power supplied from the external power source. For example, as the vibrator 241 is electrically connected to the cartridge substrate 245 positioned inside the cartridge 210, and the cartridge substrate 245 is electrically connected to the main body 250, the vibrator 241 may receive power from a battery (e.g., the battery 140 of FIG. 1 or 2).

In an embodiment, the aerosol may be generated in an atomization space (e.g., the atomization space 265 of FIG. 5A) that is positioned above the first surface 241a of the vibrator 241 and communicates with the aerosol flow channel 224. When the user inhales through the opened mouthpiece 223, the aerosol generated in the atomization space 265 may be mixed with external air introduced along the aerosol flow channel 224 and move in a direction toward the intake 225.

In an embodiment, the vibrator 241 may be electrically connected to the cartridge substrate 245 through the first electrode body 243 and the second electrode body 244.

In an embodiment, the first electrode body 243 may include a material having electrical conductivity (e.g., metal), and may contact the first surface 241a of the vibrator 241 and electrically connect the vibrator 241 and the cartridge substrate 245.

In an embodiment, the first electrode body 243 may have a tubular shape to accommodate at least a portion of the outer circumferential surface of the vibrator 241. An opening may be formed in one portion of the first electrode body 243 so that at least a portion of the vibrator 241 (e.g., the first surface 241a) may be exposed to the outside of the first electrode body 243.

For example, a portion (e.g., an upper end portion) of the first electrode body 243 may be arranged to surround at least one area of the outer circumferential surface of the vibrator 241 and contact the vibrator 241, and another portion (e.g., a lower end portion) of the first electrode body 243 may be formed to extend from the one portion in a direction toward the cartridge substrate 245 and contact one area of the cartridge substrate 245. The contact structure of the first electrode body 243 described above may allow the vibrator 241 to be electrically connected to the cartridge substrate 245.

In an embodiment, the first electrode body 243 may have an opening so that at least a portion of the vibrator 241 may be exposed to the outside of the first electrode body 243. A partial area of the first surface 241a of the vibrator 241 that is exposed to the outside of the first electrode body 243 through the opening of the first electrode body 243 may contact the transmission member 235a and/or the absorber 235b and atomize the aerosol generating material in the transmission member 235a and/or the absorber 235b.

In an embodiment, the second electrode body 244 may include a material having electrical conductivity, and may be positioned on the second surface 241b of the vibrator 241 or between the vibrator 241 and the cartridge substrate 245 to electrically connect the vibrator 241 and the cartridge substrate 245.

For example, as one end of the second electrode body 244 contacts the second surface 241b of the vibrator 241, and the other end thereof contacts the partial area of the cartridge substrate 245 facing the vibrator 241, the vibrator 241 may be electrically connected to the cartridge substrate 245.

In an embodiment, the second electrode body 244 may contact the second surface 241b of the vibrator 241 and press the vibrator 241 in a direction that the first surface 241a of the vibrator 241 faces (e.g., +z direction). The second electrode body 244 may have elasticity and support the vibrator 241 by being compressed between the support structure 247 and the other surface of the vibrator 241.

In an embodiment, the second electrode body 244 may include a conductive material having elasticity, and may serve to electrically connect the vibrator 241 and the cartridge substrate 245 and also serve to provide an elastic force to the vibrator 241 in a direction of the second surface 241b and support the vibrator 241.

For example, the second electrode body 244 may include a conductive spring, but the second electrode body 244 is not limited to the embodiment described above.

In an embodiment, the support plate 246 may be disposed between the support structure 247 and the cartridge substrate 245, and at least a portion thereof may be fastened to the cartridge substrate 245 to support the support structure 247. The support plate 246 may reinforce the fastening force between the cartridge substrate 245 and the first electrode body 243.

In an embodiment, the support plate 246 may include an inclined area having an inclination with respect to a flat area having a flat shape. The flat area and the inclined area of the support plate 246 may be integrally formed, and thus, when pressure is applied to the inclined area such that the flat area and the inclined area come closer to each other, the support plate 246 may have elasticity so that a repulsive force acts thereon.

In an embodiment, the cartridge 210 may include the support structure 247 positioned between the second surface 241b of the vibrator 241 and the cartridge substrate 245 to support the second electrode body 244.

In an embodiment, the support structure 247 may be disposed inside the first electrode body 243 to support the vibrator 241. At least a portion of the support structure 247 may be surrounded by the first electrode body 243, and at least a portion of the support structure 247 may be coupled to the first electrode body 243 in an interference fit manner.

In an embodiment, the support structure 247 may include, for example, a material having elasticity (e.g., silicone or rubber), and may be disposed to surround the outer circumferential surface of the second electrode body 244, thereby elastically supporting the second electrode body 244.

In an embodiment, one surface of the vibrator 241 may be supported by the first electrode body 243, and the other surface of the vibrator 241 may be supported by the support structure 247. The other surface of the vibrator 241 contacting the support structure 247 may press the vibrator 241 in a direction from the other surface toward the one surface by means of the support structure 247. Accordingly, it is possible to prevent the vibrator 241 from being out of position or damaged due to the vibration generated when the vibrator 241 operates.

In an embodiment, the cartridge substrate 245 may be positioned inside the second housing 205b. For example, the cartridge substrate 245 may be spaced apart from the vibrator 241 and electrically connected to the vibrator 241 through the first electrode body 243 and the second electrode body 244. The cartridge substrate 245 may be electrically connected to an internal component of the main body 250 of the aerosol generating device 200 (e.g., the main body substrate 272 of FIG. 5A).

In an embodiment, the cartridge substrate 245 may be electrically connected to the first electrode body 243 and the second electrode body 244 to supply a signal to the vibrator 241. The cartridge substrate 245 may be fastened to at least a portion of the portion of the first electrode body 243 surrounding the outer circumferential surface of the vibrator 241.

In an embodiment, as the cartridge substrate 245 is electrically connected to the vibrator 241 by the first electrode body 243 and the second electrode body 244 and is electrically connected to the main body 250 at the same time, the vibrator 241 may be electrically connected to an external power source of the cartridge 210 via the cartridge substrate 245 to receive power therefrom.

In an embodiment, the cartridge 210 may further include the reinforcing member 260 to prevent the aerosol generating material from leaking from the reservoir 230 and flowing into the aerosol flow channel 224.

For example, as at least a portion of the aerosol flow channel 224 may be disposed to be surrounded by the reservoir 230, the aerosol generating material leaking from the reservoir 230 may flow into the aerosol flow channel 224, which may decrease the smoking satisfaction of the user.

In an embodiment of the present disclosure, the reinforcing member 260 may seal a gap around the liquid supply port of the reservoir 230 (e.g., a gap between the liquid supply port and the transmission member 235a). Accordingly, in the cartridge 210 according to an embodiment, the reinforcing member 260 may prevent the aerosol generating material in the reservoir 230 from leaking into the aerosol flow channel 224, thereby preventing a decrease in the smoking satisfaction of the user.

In an embodiment, the reinforcing member 260 may prevent the aerosol generating material in the reservoir 230 from leaking into the aerosol flow channel 224. For example, the reinforcing member 260 may have a circular hollow shape. The reinforcing member 260 may fit into the inside of the first housing 205a and come into close contact with an outer wall of the reservoir 230.

In an embodiment, since the reinforcing member 260 has a passage portion therein, the reinforcing member 300 may prevent the aerosol generating material from flowing from the reservoir 230 into the aerosol flow channel 224 and simultaneously forming a portion of the aerosol flow channel 224 through which the aerosol generated from the vibrator 241 moves.

In an embodiment, the reinforcing member 260 may include at least one hole connected to the aerosol flow channel 224. For example, the reinforcing member 260 may include a second opening (e.g., the second opening 262 of FIG. 5A) in a top surface (e.g., a surface in the +z direction).

In an embodiment, the atomization space 265 may be positioned above the first surface 241a of the vibrator 241 facing the aerosol flow channel 224, such that the atomization space 265 and the aerosol flow channel 224 may communicate at the upper end of the vibrator 241. The cartridge 210 may have a straight aerosol discharge path, and the generated aerosol may be easily discharged to the outside of the cartridge 210.

In an embodiment, the second opening 262 may be formed so that the aerosol generated in the atomization space 265 may move to the aerosol flow channel 224. For example, the second opening 262 may be formed at a portion of the reinforcing member 260 where the atomization space 265 faces the aerosol flow channel 224, and the aerosol that is generated in the atomization space 265 and flows in one direction (e.g., +z direction) may move toward the mouthpiece 223 through the second opening 262.

In an embodiment, the reinforcing member 260 may include a material having elasticity (e.g., rubber) to absorb ultrasonic vibration generated from the vibrator 241. Accordingly, the transmission of ultrasonic vibration generated from the vibrator 241 through the housing 205 of the cartridge 210 to the user may be minimized.

In an embodiment, the reinforcing member 260 may be positioned at the upper end of the transmission member 235a to press the transmission member 235a in a direction toward the vibrator 241.

The cartridge 210 according to an embodiment may further include a waterproof member 249 for maintaining the transmission member 235a and/or the vibrator 241 inside the first housing 205a.

In an embodiment, the waterproof member 249 may be disposed to surround at least a portion of outer circumferential surfaces of the transmission member 235a, the absorber 235b, and/or the vibrator 241, thereby accommodating the transmission member 235a, the absorber 235b, and/or the vibrator 241.

In an embodiment, the waterproof member 249 may be disposed between the first housing 205a and the second housing 205b, and the transmission member 235a, the absorber 235b, and/or the vibrator 241 may be maintained or secured in an area between the first housing 205a and the second housing 205b.

In an embodiment, the waterproof member 249 may be coupled to the first housing 205a in a manner of interference fit of at least a partial area of the waterproof member 249 to the first housing 205a, but the method of coupling the first housing 205a and the waterproof member 249 is not limited to the example described above. In another example, the first housing 205a and the waterproof member 249 may be coupled by at least one method of the snap-fit method, screw coupling method, or magnetic coupling method.

In an embodiment, the waterproof member 249 may include a material having a predetermined rigidity and waterproofness (e.g., silicone or rubber) to secure the transmission member 235a and the vibrator 241 to the first housing 205a and to prevent the aerosol generating material from leaking from the reservoir 230. For example, the waterproof member 249 may seal an area where the reservoir 230 is adjacent to the transmission member 235a or the vibrator 241, thereby preventing leakage of the aerosol generating material.

In an embodiment, like the reinforcing member 260, the waterproof member 249 may include a material having elasticity (e.g., rubber) to absorb ultrasonic vibration generated from the vibrator 241.

In an embodiment, the waterproof member 249 may include a securing protrusion 249a protruding in a direction of the wick 235. The securing protrusion 249a may be inserted into a securing recess 235c formed in the transmission member 235a of the wick 235, and the securing protrusion 249a may support or secure the wick 235.

In an embodiment, the cartridge 210 may further include a first sealing body 236 for maintaining the coupling between the first housing 205a and the third housing 205c and sealing the reservoir 230.

In an embodiment, the first sealing body 236 may be disposed between the first housing 205a and the third housing 205c. For example, the first sealing body 236 may be coupled to the upper end of the first housing 205a and the lower end of the third housing 205c, thereby firmly maintaining the coupling between the first housing 205a and the third housing 205c.

In an embodiment, the first sealing body 236 may include a structure that selectively seals the reservoir 230 while not sealing the aerosol flow channel 224. For example, the first sealing body 236 may have a hole formed in a portion in which the aerosol flow channel 224 is positioned and an air flow channel 270 formed in a portion in which the reservoir 230 is positioned, based on a state in which the first sealing body 236 is coupled to the upper end of the first housing 205a. The first seal 236 may separate the reservoir 230 from the aerosol flow channel 224 at the upper end of the first housing 205a while preventing the aerosol flow channel 224 from being blocked.

In an embodiment, the air flow channel 270 may communicate the reservoir 230 with the outside. For example, one side of the air flow channel 270 may communicate with the reservoir 230, and the other side of the air flow channel 270 may communicate with the outside of the cartridge 210 or the outside of an aerosol generating device (e.g., the aerosol generating device 200 of FIGS. 3A and 3B). The air flow channel 270 may be opened and closed by the mouthpiece 223.

In an embodiment, the cartridge 210 may further include a second sealing body 238 coupled to the third housing 205c to seal the periphery of the aerosol flow channel 224. The second sealing body 238 may be coupled to an upper end of the third housing 205c. The second sealing body 238 may include a hole having a size corresponding to that of the aerosol flow channel 224 to seal the periphery of a portion where the aerosol flow channel 224 and the intake 225 are connected while preventing the aerosol flow channel 224 from being blocked.

In an embodiment, the cartridge 210 may include both the first sealing body 236 and the second sealing body 238.

In an embodiment, the first sealing body 236 and the second sealing body 238 may be coupled to the upper and lower ends of the third housing 205c, respectively, and at least a portion of the first sealing body 236 and the second sealing body 238 may be partially coupled inside the third housing 205c. Accordingly, the first housing 205a and the third housing 205c may be more firmly coupled via the first sealing body 236 and the second sealing body 238.

In an embodiment, the first sealing body 236 and the second sealing body 238 may be coupled to the first housing 205a and/or the third housing 205c in a manner of interference fit, but the method of coupling the sealing body 236 and the second sealing body 238 is not limited to the example described above.

In an embodiment, the first sealing body 236 and the second sealing body 238 may include a material having a predetermined rigidity and waterproofness (e.g., silicone) to be firmly coupled to the first housing 205a and/or the third housing 205c and function as a part of the inner wall of the aerosol flow channel 224.

For example, in the process of atomizing the aerosol generating material by the vibrator 241, a portion of the aerosol generating material may not be sufficiently atomized and droplets with relatively large particles may be generated. Alternatively, droplets may be generated as a portion of the atomized aerosol is liquefied inside an airflow path. The generated droplets may block the aerosol flow channel 224, leak to the outside of the cartridge 210 through another path (e.g., an inlet 251 of FIG. 5A), or leak to the outside of the mouthpiece 223 through the intake 225, which may decrease the convenience and smoking satisfaction of the user. The first sealing body 236 and the second sealing body 238 may prevent the foregoing issue and provide convenience and smoking satisfaction to the user.

FIG. 5A is a cross-sectional view of the aerosol generating device 200 according to an embodiment, and FIG. 5B is an enlarged cross-sectional view of the aerosol generating device 200 according to an embodiment. Specifically, FIG. 5B is an enlarged view of the area A shown in FIG. 5A.

Referring to FIGS. 5A and 5B, the aerosol generating device 200 according to an embodiment may include the temperature sensor 271 and a lens 273.

The cartridge 210 inserted into the aerosol generating device 200 described below may be the cartridge 210 of FIG. 4, but is not limited thereto. Hereinafter, in describing the aerosol generating device 200 with the cartridge 210 inserted thereinto, the description provided above will not be repeated.

In an embodiment, the cartridge 210 may be detachably coupled to the cartridge fastening area 255 of the main body 250. The cartridge fastening area 255 may be a portion of the main body 250 to which the cartridge 210 is coupled. A securing member 255a may hold or secure the mouthpiece 223 in the closed position.

In an embodiment, the cartridge fastening area 255 may accommodate at least a portion of the cartridge 210. For example, the cartridge fastening area 255 may have a shape corresponding to that of at least a partial area of the cartridge 210 (e.g., a partial area of the housing 205), so that at least a partial area of the mouthpiece 223 of the cartridge 210 and a cartridge body (e.g., the cartridge body 221 of FIG. 4) may be accommodated or inserted therein.

In an embodiment, a first magnetic body (not shown) may be included in at least one area of the cartridge body 221 of the cartridge 210, and a second magnetic body (not shown) may be included in at least one area of the cartridge fastening area 255 of the main body 250. For example, the first magnetic body (not shown) may be disposed on a lower surface of the cartridge body 221, and the second magnetic body (not shown) may be disposed on a bottom surface of the cartridge fastening area 255 of the main body 250 facing the lower surface of the inserted cartridge body 221. Accordingly, the cartridge 210 inserted to a predetermined position in the cartridge fastening area 255 may be coupled by the magnetic force.

In an embodiment, the aerosol generating device 200 may include the securing member 255a for holding the mouthpiece 223 in a predetermined position. For example, the main body 250 may include the securing member 255a for holding the closed mouthpiece 223 in the closed position. The securing member 255a may be positioned in a partial area of the cartridge fastening area 255 where the mouthpiece 223 in the closed position is stored.

In an embodiment, when closing the mouthpiece 223, the user may apply an external force to move the mouthpiece 223 from the open position to the closed position. When the mouthpiece 223 is moved to the closed position, the securing member 255a may provide a holding force to the mouthpiece 223 to hold the mouthpiece 223 in the closed position. For example, the securing member 255a may provide magnetic, elastic, and/or frictional forces to one end of the mouthpiece 223 to hold the mouthpiece 223 in the closed position.

In an embodiment, when opening the mouthpiece 223, the user may apply an external force to the mouthpiece 223 to move the mouthpiece 223 from the closed position to the open position. For example, when the user presses the other side of the mouthpiece 223 with a predetermined force or stronger, the mouthpiece 223 may be released from the securing member 255a, and the mouthpiece 223 may rotate from the closed position to the open position.

In an embodiment, one end of the securing member 255a and one end of the mouthpiece 223 may each include a magnetic body having an opposite polarity. Accordingly, when one end of the mouthpiece 223 is brought closer to the closed position by a predetermined distance, the mouthpiece 223 may be pulled by the magnetic force and held in the closed position.

In an embodiment, the aerosol generating device 200 may further include an inhalation detection sensor (not shown). The inhalation detection sensor (not shown) may sense whether the user inhales through the aerosol generating device 200, by detecting a change in internal pressure or an airflow of the aerosol generating device 200.

In an embodiment, the inhalation detection sensor (not shown) may be positioned anywhere in the cartridge 210 or the main body 250. Since the cartridge 210 may be a consumable that is replaced when the aerosol generating material stored therein is used up, the inhalation detection sensor (not shown) may be preferably positioned in the main body 250.

In an embodiment, the inhalation detection sensor (not shown) may be positioned adjacent to the cartridge fastening area 255 of the main body 250. For example, the inhalation detection sensor (not shown) may be positioned in one area of the cartridge fastening area 255 adjacent to the outer circumferential surface of the cartridge 210 coupled to the main body 250. As another example, the inhalation detection sensor (not shown) may be positioned in one area of the main body 250 facing the outer circumferential surface of the housing 205 of the cartridge 210 coupled to the main body 250.

In an embodiment, since outside air may be introduced into the aerosol generating device 200 through a fine gap between the main body 250 and the cartridge 210 being coupled, the inhalation detection sensor (not shown) may be disposed adjacent to an area where the outside air flows, to more accurately detect a change in internal pressure or an airflow of the main body 250.

In an embodiment, the main body 250 may include at least one inlet 251 through which air outside the main body 250 may be introduced into the main body 250 and the cartridge 210. The inlet 251 may communicate with the inside of the cartridge 210 through at least one opening formed in the cartridge 210 (e.g., the sensor hole 207).

In an embodiment, the reinforcing member 260 may include the first opening 261, the atomization space 265, and the second opening 262. The first opening 261 may be formed on the lower surface or bottom surface of the reinforcing member 260. The first opening 261 may be formed to be open in a direction facing the transmission member 235a of the wick 235 and/or the vibrator 241. The reinforcing member 260 may communicate from the wick 235 to the atomization space 265 through the first opening 261. The second opening 262 may be formed between the atomization space 265 and the aerosol flow channel 224, so that the aerosol generated in the atomization space 265 may pass through the second opening 262 and be transmitted to the aerosol flow channel 224.

In an embodiment, the airflow may move in a forward direction from the inlet 251 through the atomization space 265 of the reinforcing member 260 toward the intake 225. In this case, the “forward direction” may refer to a direction in which airflow moves when the user inhales through the mouthpiece 223. For example, the forward direction may be a direction from the inlet 251 toward the atomization space 265 and a direction from the atomization space 265 toward the intake 225.

In an embodiment, the lens 273 may be disposed on one surface (e.g., a bottom surface) of the cartridge fastening area 255. In an embodiment, the lens 273 may be disposed to face a partial area of the cartridge 210 (e.g., the sensor hole 207 of the cartridge 210) while the cartridge 210 is coupled to the main body 250.

In an embodiment, the temperature sensor 271 may be positioned to face the cartridge fastening area 255 in the main body 250. The temperature sensor 271 may be configured as an infrared sensor.

For example, the temperature sensor 271 may include a light emitter that emits infrared rays and a light receiver that detects infrared rays returning after reflected from a target object. The temperature sensor 271 may sense the temperature of the target object through the amount of light detected by the light receiver.

For example, the temperature sensor 271 according to an embodiment may not include a light emitter but include a light receiver. The light receiver may sense the temperature of the target object through the wavelength of light emitted and/or reflected from the target object. However, this is an exemplary description of driving the temperature sensor 271 which is an infrared sensor according to an embodiment, and is not limited thereto in practical implementation and may be implemented in various manners.

In an embodiment, the temperature sensor 271 may be connected to the main body substrate 272. Alternatively, the temperature sensor 271 may be mounted or disposed on the main body substrate 272. The main body substrate 272 may be positioned inside the main body 250 and may control the overall driving of the aerosol generating device 200.

In an embodiment, the main body substrate 272 may be a controller (e.g., the controller 110 of FIG. 1 or 2) itself of the aerosol generating device 200, or may be part thereof. For example, the controller 110 may include the cartridge substrate 245 and the main body substrate 272. The cartridge substrate 245 and the main body substrate 272 may be electrically and/or communicatively connected to each other.

In an embodiment, the main body substrate 272 may be connected to the inside of the cartridge body 221 of the cartridge 210 through a cable or wire, and may be connected to the cartridge substrate 245 of the cartridge 210. Since the cartridge substrate 245 of the cartridge 210 is in electrical contact with the vibrator 241, the vibrator 241 may be electrically connected to the main body 250 via the cartridge substrate 245. The driving of the vibrator 241 may be controlled by the main body substrate 272, or the vibrator 241 may receive power from a battery (e.g., the battery 140 of FIG. 1 or 2) of the main body 250.

In an embodiment, the temperature sensor 271 may sense the temperature of the second surface 241b of the vibrator 241. The vibrator 241 may be driven to generate vibration and thereby emit heat, and when the vibrator 241 is overheated, the vibrator 241 or peripheral parts may be damaged or the performance of the vibrator 241 may decrease. The temperature sensor 271 may substantially directly sense the temperature of the second surface 241b of the vibrator 241, and the controller may control the driving of the vibrator 241 based on the sensing result.

In an embodiment, when the vibrator 241 is heated, the temperature of the central area of the second surface 241b of the vibrator 241 may first change. For the temperature sensor 271 to sense the temperature of the central area of the second surface 241b of the vibrator 241, obstacles between the temperature sensor 271 and the vibrator 241 may be removed or minimized, or a path between the temperature sensor 271 and the vibrator 241 may be shortened, and/or a path of light between the temperature sensor 271 and the vibrator 241 may be controlled. Through this, the temperature sensor 271 may quickly and accurately detect a change in the temperature of the vibrator 241.

In an embodiment, when at a far distance from the target object, the temperature sensor 271 which is an infrared sensor may have a low accuracy of the detection result and have difficulties in quickly detecting a temperature change. In an embodiment, the lens 273 may be positioned between the sensor hole 207 and the temperature sensor 271. The lens 273 may widen the sensing range of the temperature sensor 271 (or the angle of view of the temperature sensor 271 which is an infrared sensor).

For example, the lens 273 may condense light emitted from the temperature sensor 271 and control an optical path toward the second surface 241b of the vibrator 241, and/or the lens 273 may condense light reflected from the vibrator 241 (or light returning after emitted from the temperature sensor 271 and then reflected from the vibrator 241) and control an optical path toward the temperature sensor 271. Through the lens 273, the temperature sensor 271 may accurately and quickly sense a change in the temperature of the vibrator 241.

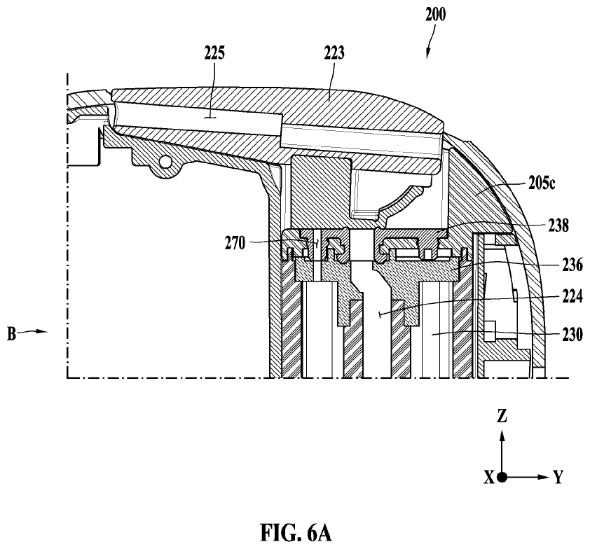

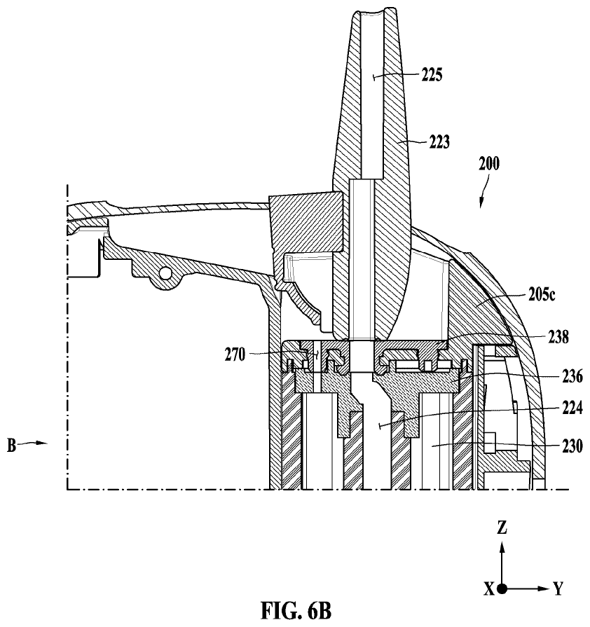

FIG. 6A is a cross-sectional view of the aerosol generating device 200 according to an embodiment, and FIG. 6B is an enlarged cross-sectional view of the aerosol generating device 200 according to an embodiment.

Specifically, FIGS. 6A and 6B are enlarged views of the area B shown in FIG. 5A.

Referring to FIGS. 6A and 6B, the air flow channel 270 according to an embodiment may be opened and closed by the mouthpiece 223.

Hereinafter, the description provided above is not repeated, and it is obvious that a portion of the components and structure of the aerosol generating device 200 may be replaced, added, or omitted within a scope easily understandable by one of ordinary skill in the art with reference to the following diagrams and descriptions. In addition, at least one component or feature of the embodiments described above may be coupled to the aerosol generating device 200 unless this is technically and clearly infeasible.

In an embodiment, the air flow channel 270 may be opened from the inside of the reservoir 230 in a direction facing the mouthpiece 223. The air flow channel 270 may supply air into the reservoir 230 and may control the pressure inside the reservoir 230.

For example, as the aerosol generating device 200 is driven, an aerosol generating material inside the reservoir 230 may move to the wick 235 and be atomized. As the aerosol generating material inside the reservoir 230 decreases, the pressure inside the reservoir 230 may gradually decrease. As the pressure inside the reservoir 230 decreases, air backflow may occur from an atomization space 265 in the wick 235 toward the reservoir 230. Due to the air backflow, the aerosol generating material may not be smoothly transferred to the wick 235, and the liquid transport efficiency of the reservoir 230 may be reduced.

In an embodiment of the present disclosure, the air path flow 270 may supply air into the reservoir 230 by selectively connecting the inside of the reservoir 230 to the outside of the reservoir 230. The air path flow 270 may prevent pressure drop inside the reservoir 230 due to driving of the aerosol generating device 200 and improve the liquid transport efficiency of the reservoir 230.

In an embodiment, the air flow channel 270 may be opened or closed by hinge-driven motion of the mouthpiece 223. The mouthpiece 223 may be driven by hinge motion based on a hinge axis (e.g., an X-axis). Through hinge-driven motion, the mouthpiece 223 may selectively allow the intake 225 of the mouthpiece 223 and the aerosol flow channel 224 to communicate with each other.

In an embodiment, one end (e.g., the end in the −Z direction) of the air flow channel 270 may communicate with the reservoir 230, and the other end (e.g., the end in the +Z direction) of the air flow channel 270 may be in contact with a partial area (e.g., the support portion 223b of FIG. 4) of the mouthpiece 223. As the mouthpiece 223 is driven by hinge motion, the other end of the air flow channel 270 may be opened and closed.

In an embodiment, the mouthpiece 223 may be driven by hinge motion between a first position (e.g., the position of the mouthpiece 223 in FIG. 6A) at which the aerosol flow channel 224 is disconnected from the intake 225 and a second position (e.g., the position of the mouthpiece 223 in FIG. 6B) at which the aerosol flow channel 224 communicates with the intake 225.

In an embodiment, the mouthpiece 223 may move between the first position and the second position, close the air flow channel 270 at the first position and open the air flow channel 270 at the second position.

For example, in a state in which the mouthpiece 223 is at the first position as shown in FIG. 6A (or in a state in which the mouthpiece 223 is closed or a state in which the aerosol generating device 200 is not in use), the other end of the air flow channel 270 may be in contact with the mouthpiece 223, and the air flow channel 270 may be closed.

For example, in a state in which the mouthpiece 223 is at the second position as shown in FIG. 6B (or in a state in which the mouthpiece 223 is opened or a state in which the aerosol generating device 200 is in use), the other end of the air flow channel 270 may be spaced apart from the mouthpiece 223 and the air flow channel 270 may be opened.

In an embodiment of the present disclosure, the air flow channel 270 may be opened and closed in conjunction with the mouthpiece 223 and thus, may be selectively opened only in a situation in which the aerosol generating device 200 is used. The air flow channel 270 may be closed when the aerosol generating device 200 is not in use, thereby preventing leakage of the aerosol generating material. The air flow channel 270 may be automatically opened in conjunction with the mouthpiece 223 when the aerosol generating device 200 is in use, thereby preventing a decrease in pressure inside the reservoir 230 and improving the liquid transport capacity of the reservoir 230.

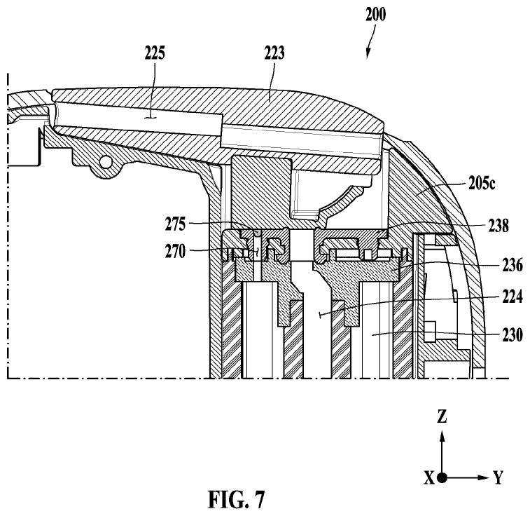

FIG. 7 is an enlarged cross-sectional view of the aerosol generating device 200 according to an embodiment.

Referring to FIG. 7, the aerosol generating device 200 according to an embodiment may further include a sealing member 275.

Hereinafter, the description provided above is not repeated, and it is obvious that a portion of the components and structure of the aerosol generating device 200 may be replaced, added, or omitted within a scope easily understandable by one of ordinary skill in the art with reference to the following diagrams and descriptions. In addition, at least one component or feature of the embodiments described above may be coupled to the aerosol generating device 200 unless this is technically and clearly infeasible.

In an embodiment, the sealing member 275 may be disposed at a position opposite to the air flow channel 270 in the mouthpiece 223. The sealing member 275 may seal the air flow channel 270 to prevent a liquid aerosol generating material from leaking from the reservoir 230.

In an embodiment, the sealing member 275 may be inserted into the air flow channel 270 in a state in which the mouthpiece 223 is at the first position (e.g., the state of the mouthpiece 223 of FIG. 7). However, FIG. 7 is only an embodiment of the sealing member 275, and in practical implementation, the structure and driving of the sealing member 275 are not limited thereto.

For example, the sealing member 275 may be a sealing pad attached to at least a partial area of one surface (e.g., the surface in the −Z direction) of the mouthpiece 223. Alternatively, the sealing member 275 may have a cover or cap structure that surrounds the other end of the air flow channel 270 (e.g., the end in the +Z direction).

In an embodiment, the sealing member 275 may be formed of an elastomer such as rubber, silicone, or thermoplastic polyurethane (TPU). Additionally, the sealing member 275 may be formed of a water-repellent material.

In an embodiment of the present disclosure, the mouthpiece 223 or the sealing member 275 may correspond to an exemplary valve for controlling the opening and closing of the air flow channel 270. However, the structure and driving of the valve are not limited thereto, and the aerosol generating device 200 may include valves of various structures and driving techniques.

For example, although not shown in the drawing, the aerosol generating device 200 according to an embodiment may further include a valve that is driven in an electronically automatic manner. The driving of the valve may be controlled by a processor (e.g., the controller 110 of FIG. 1).

In an embodiment, the processor may control the driving of the vibrator 241 and the valve. The processor may open the valve when the driving of the vibrator 241 is initiated.

For example, as the vibrator 241 is driven, an aerosol generating material in the reservoir 230 may move and the pressure inside the reservoir 230 may decrease, and accordingly, the valve may open the air flow channel 270 and supply air into the reservoir 230.

In an embodiment, the aerosol generating device 200 may further include a sensor (e.g., the sensing unit 120 of FIG. 1) for detecting hinge-driven motion. The sensor may provide a detection result to the processor, and the processor may open the valve when hinge-driven motion of the mouthpiece 223 is detected.

In an embodiment, the processor may receive a detection result from a puff sensor (e.g., the puff sensor 126 of FIG. 1), and the processor may open the valve when a puff motion of a user is detected.

In an embodiment of the present disclosure, the processor may accurately and precisely control the pressure in the reservoir 230 by controlling the valve in an electronically automatic manner to open and close the air flow channel 270.

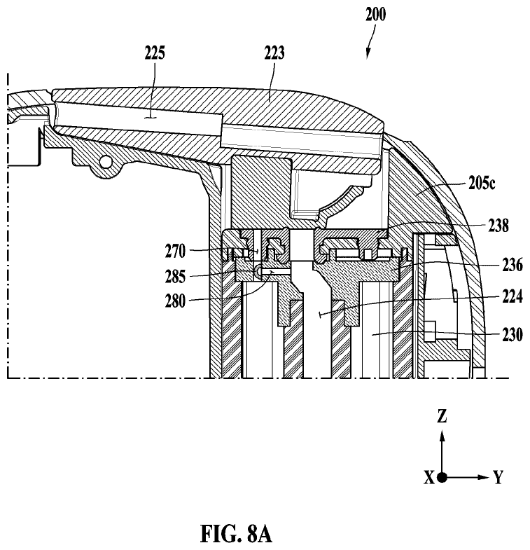

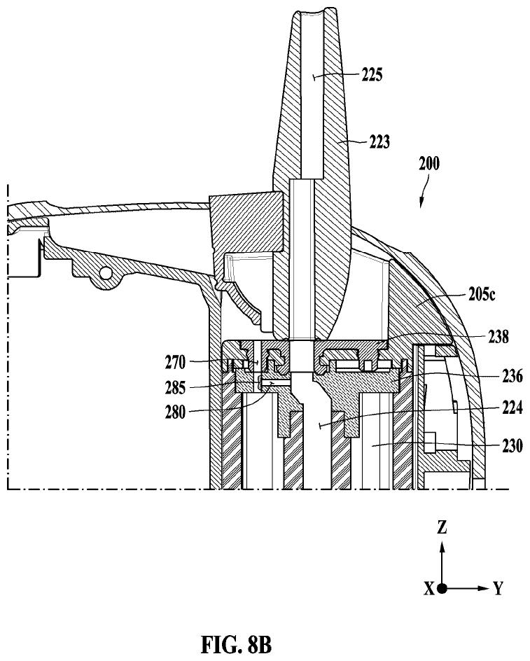

The above description is an example description of the driving for opening and closing the air flow channel 270 of the aerosol generating device 200, the practical implementation of the aerosol generating device 200 is not limited thereto, and the aerosol generating device 200 may be implemented in various structures and driving techniques. FIG. 8A is a cross-sectional view of the aerosol generating device 200 according to an embodiment, and FIG. 8B is an enlarged cross-sectional view of the aerosol generating device 200 according to an embodiment.

Referring to FIGS. 8A and 8B, the aerosol generating device 200 according to an embodiment may further include an auxiliary flow channel 280 and an elastic member 285.

Hereinafter, the description provided above is not repeated, and it is obvious that a portion of the components and structure of the aerosol generating device 200 may be replaced, added, or omitted within a scope easily understandable by one of ordinary skill in the art with reference to the following diagrams and descriptions. In addition, at least one component or feature of the embodiments described above may be coupled to the aerosol generating device 200 unless this is technically and clearly infeasible.

In an embodiment, one side (e.g., the −Y direction of FIGS. 8A and 8B) of the auxiliary flow channel 280 may be opened toward the air flow channel 270. The other side (e.g., +Y direction in FIGS. 8A and 8B) opposite to the one side of the auxiliary flow channel 280 may communicate with the aerosol flow channel 224.

In an embodiment, the elastic member 285 may be disposed to enclose one side of the auxiliary flow channel 280 in the air flow channel 270. The elastic member 285 may seal one end of the auxiliary flow channel 280.

In an embodiment, the elastic member 285 may disconnect the auxiliary flow channel 280 from the air flow channel 270. The elastic member 285 may prevent an aerosol passing through the aerosol flow channel 224 from being transmitted to the air flow channel 270 through the auxiliary flow channel 280.

In an embodiment, the elastic member 285 may deform based on an air pressure change in the auxiliary flow channel 280. For example, the elastic member 285 may deform depending on the change in air pressure in the auxiliary flow channel 280. Alternatively, for example, the elastic member 285 may expand or contract depending on the air pressure change in the auxiliary flow channel 280. By undergoing deformation, the elastic member 285 may selectively open and close the air flow channel 270.

For example, as shown in FIG. 8A, in a state in which the mouthpiece 223 is at a first position (or a state in which the mouthpiece 223 is closed or a state in which the aerosol generating device 200 is not in use) or in a state in which a user does not inhale air through the mouthpiece 223, the elastic member 285 may be in a pre-deformation state (or an expanded state). The elastic member 285 before deformation may be disposed to block the air flow channel 270, thereby blocking the flow of a fluid in the air flow channel 270.

For example, as shown in FIG. 8B, when the user inhales air through the mouthpiece 223 in a state in which the mouthpiece 223 is at a second position (or a state in which the mouthpiece 223 is opened or a state in which the aerosol generating device 200 is in use), the pressure in the intake 225 and the aerosol flow channel 224 may be relatively reduced and may be in a low-pressure state. When the aerosol flow channel 224 is in a low-pressure state, the pressure in the auxiliary flow channel 280 communicating with the aerosol flow channel 224 may be lowered. The elastic member 285 may deform (or contract) when the air pressure in the auxiliary path 280 decreases. The elastic member 285 in a deformed state may open the air flow channel 270, so the air flow channel 270 may temporarily supply external air to the reservoir 230.

In an embodiment, the elastic member 285 may be formed of an elastomer such as rubber, silicone, or TPU. Additionally, the elastic member 285 may be formed of a water-repellent material.

In an embodiment of the present disclosure, the elastic member 285 may deform in response to the air pressure change in the aerosol flow channel 224 and the auxiliary flow channel 280 and may selectively open and close the air flow channel 270. The auxiliary flow channel 280 and the elastic member 285 may selectively open the air flow channel 270 only in a situation in which the aerosol generating device 200 is in use. The air flow channel 270 may be closed when the user does not inhale through the aerosol generating device 200, thereby preventing leakage of an aerosol generating material inside the reservoir 230. The air flow channel 270 may be automatically opened when the user inhales through the aerosol generating device 200, thereby supplying air into the reservoir 230 and preventing a decrease in pressure in the reservoir 230.

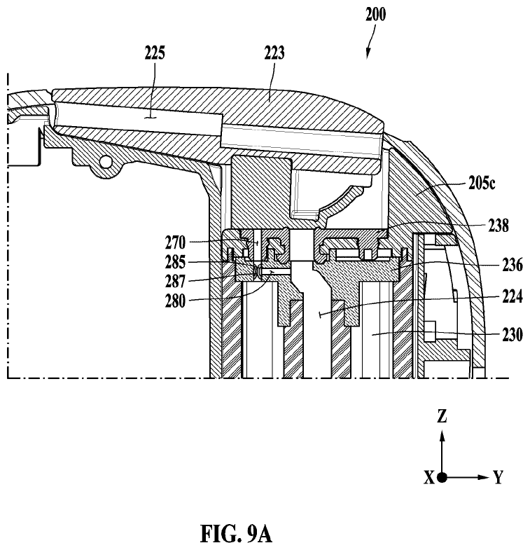

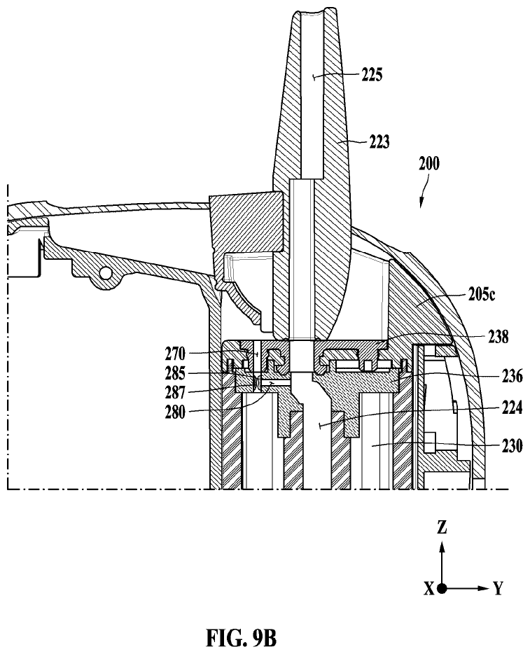

FIG. 9A is a cross-sectional view of the aerosol generating device 200 according to an embodiment, and FIG. 9B is an enlarged cross-sectional view of the aerosol generating device 200 according to an embodiment.

Referring to FIGS. 9A and 9B, the aerosol generating device 200 according to an embodiment may further include a leakage prevention member 287.

Hereinafter, the description provided above is not repeated, and it is obvious that a portion of the components and structure of the aerosol generating device 200 may be replaced, added, or omitted within a scope easily understandable by one of ordinary skill in the art with reference to the following diagrams and descriptions. In addition, at least one component or feature of the embodiments described above may be coupled to the aerosol generating device 200 unless this is technically and clearly infeasible.

In an embodiment, the leakage prevention member 287 may be disposed to face the elastic member 285 in the air flow channel 270. The leakage prevention member 287 may be disposed such that at least a partial area of the leakage prevention member 287 is in contact with the elastic member 285 based on a state in which the elastic member 285 does not deform (e.g., a state of the elastic member 285 of FIG. 9A), thereby preventing a liquid aerosol generating material from leaking through the air flow channel 270.

For example, in a state in which the mouthpiece 223 is at a first position as shown in FIG. 9A (or a state in which the mouthpiece 223 is closed or a state in which the aerosol generating device 200 is not in use) or a state in which a user does not inhale air through the mouthpiece 223, the leakage prevention member 287 may seal the air flow channel 270 by being in contact with the elastic member 285 in a pre-deformation state (or an expanded state). The elastic member 285 in the pre-deformation state and the leakage prevention member 287 may block the air flow channel 270 and block the flow of fluid in the air flow channel 270.

For example, when the user inhales air through the mouthpiece 223 in a state in which the mouthpiece 223 is at a second position (or in a state in which the mouthpiece 223 is opened or a state in which the aerosol generating device 200 is in use), as shown in FIG. 9B, the air pressure in the auxiliary flow channel 280 may decrease and the elastic member 285 may deform (or contract). When the elastic member 285 deforms, the leakage prevention member 287 and the elastic member 285 may be at least partially separated from each other. The elastic member 285 in the deformed state and the leakage prevention member 287 may be at least partially spaced apart from each other to open the air flow channel 270, and the air flow channel 270 may supply external air to the reservoir 230.

In an embodiment, the leakage prevention member 287 may be formed of an elastomer such as rubber, silicone, or TPU. Additionally, the leakage prevention member 287 may be formed of a water-repellent material.

In an embodiment, the leakage prevention member 287 may have a shape corresponding to the shape of the elastic member 285 before deformation. For example, when the elastic member 285 has a cap, hemisphere, polygon, or curved structure protruding toward the inside of the air flow channel 270, the leakage prevention member 287 may have a shape that encloses a portion or an entirety of the elastic member 285 to seal the air flow channel 270.

In an embodiment of the present disclosure, the leakage prevention member 287 may seal the elastic member 285 and seal the air flow channel 270 when the user does not inhale through the aerosol generating device 200, thereby preventing a liquid aerosol generating material from leaking through the air flow channel 270.

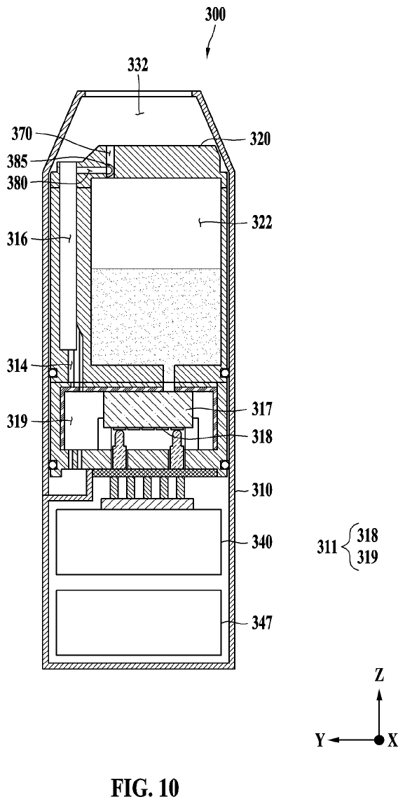

FIG. 10 is a cross-sectional view of an aerosol generating device 300 according to an embodiment.

Referring to FIG. 10, the aerosol generating device 300 (e.g., the aerosol generating device 1 of FIG. 1 or FIG. 2 or the aerosol generating device 200 of any one of FIGS. 3A to 9B) according to an embodiment may include at least a portion of a housing 310 and a cartridge 320.

Hereinafter, the description provided above is not repeated, and it is obvious that a portion of the components and structure of the aerosol generating device 300 may be replaced, added, or omitted within a scope easily understandable by one of ordinary skill in the art with reference to the following diagrams and descriptions. In addition, at least one component or feature of the embodiments described above may be coupled to the aerosol generating device 300 unless this is technically and clearly infeasible.

The housing 310 according to an embodiment may be a main housing of the aerosol generating device 300 and may accommodate electrical components of the aerosol generating device 300 therein. The housing 310 may include an intake 332. A user may inhale an aerosol through the intake 332.

In an embodiment, the housing 310 may further include at least a portion of a cartridge flow channel 314 and an aerosol flow channel 316. The cartridge flow channel 314 may communicate with the cartridge 320. The cartridge flow channel 314 may be an opening through which an aerosol is transmitted from the cartridge 320.

In an embodiment, the aerosol flow channel 316 may communicate with the cartridge flow channel 314 and the intake 332. The aerosol flow channel 316 may receive an aerosol from the cartridge 320 through the cartridge flow channel 314.

In an embodiment, the cartridge 320 may be coupled with the housing 310. The cartridge 320 may accommodate an aerosol generating material having at least some of a liquid state, a solid state, a gaseous state, and a gel state. The cartridge 320 may be operated by an electric signal or a wireless signal transmitted from the housing 310 and may generate an aerosol by converting the phase of the accommodated aerosol generating material into a gas phase.

In an embodiment, the aerosol generated from the aerosol generating material in the cartridge 320 may pass through the cartridge flow channel 314 and travel along the aerosol flow channel 316. The aerosol flow channel 316 may transfer the aerosol to the intake 332, and the aerosol may be transferred to the user.

In an embodiment, an atomization unit 311 may generate an aerosol from the aerosol generating material. The atomization unit 311 may include a heater 318 and an atomization space 319. Additionally, the atomization unit 311 may include a wick 317 that receives an aerosol generating material and is heated by the heater 318.

In an embodiment, the atomization space 319 may communicate with the intake 332. For example, the atomization space 319 may communicate with the cartridge flow channel 314, and the atomization space 319 may communicate with the intake 332 via the aerosol flow channel 316.

In an embodiment, a reservoir 322 may be provided inside the cartridge 320. The reservoir 322 may accommodate and store an aerosol generating material therein. The aerosol generating material may include a liquid composition. The liquid composition may be, for example, a liquid including a tobacco-containing material that includes a volatile tobacco flavor component or may be a liquid including a non-tobacco material.

In an embodiment, when the aerosol generating material is transferred to the wick 317, the liquid composition may be heated by the heater 318, and an aerosol may be generated. The generated aerosol may be transferred to the user.

In an embodiment, the cartridge flow channel 314 may communicate with the atomization space 319. The cartridge flow channel 314 may communicate with the aerosol flow channel 316 so that the aerosol generated in the atomization space 319 may be transferred to the aerosol flow channel 316.

In an embodiment, the aerosol flow channel 316 may communicate with the intake 332 of the housing 310. The aerosol flow channel 316 may transfer an aerosol from the atomization space 319 to the intake 332. The aerosol generated by the atomization unit 311 may pass through the cartridge flow channel 314 and the aerosol flow channel 316 and move to the intake 332.

In an embodiment, the aerosol generating device 300 may further include at least a portion of a processor 340 (e.g., the controller 110 of FIG. 1) and a battery 347 (e.g., the battery 140 of FIG. 1).

In an embodiment, the processor 340 may control driving of the aerosol generating device 300. The battery 347 may store power for driving the aerosol generating device 300 and provide the power to a component of the aerosol generating device 300.

In an embodiment, the aerosol generating device 300 may further include at least some of an air flow channel 370 (e.g., the air flow channel 270 of at least one of FIGS. 4 to 9B), an auxiliary flow channel 380 (e.g., the auxiliary flow channel 280 of at least one of FIGS. 8A to 9B), and an elastic member 385 (e.g., the elastic member 285 of at least one of FIGS. 8A to 9B).

In an embodiment, the air flow channel 370 may be opened from the inside of the reservoir 322 in a direction facing the intake 332 (or a mouthpiece). The air flow channel 370 may supply air into the reservoir 322 and may control the pressure inside the reservoir 322.

In an embodiment of the present disclosure, the air path flow 370 may supply air into the reservoir 322 by selectively connecting the inside of the reservoir 322 to the outside of the reservoir 322. The air path flow 370 may prevent pressure drop inside the reservoir 322 due to driving of the aerosol generating device 300 and improve the liquid transport efficiency of the reservoir 322.

In an embodiment, one side (e.g., +Y direction in FIG. 10) of the auxiliary flow channel 380 may be opened toward the air flow channel 370. The other side (e.g., −Y direction in FIG. 10) opposite to one side of the auxiliary flow channel 380 may communicate with the aerosol flow channel 324.

In an embodiment, the elastic member 385 may be disposed to enclose one side of the auxiliary flow channel 380 in the air flow channel 370. The elastic member 385 may seal one end of the auxiliary flow channel 380. The auxiliary flow channel 380 and the air flow channel 370 may be disconnected from each other by the elastic member 385. The elastic member 385 may prevent an aerosol passing through the aerosol flow channel 324 from being transmitted to the air flow channel 370 through the auxiliary flow channel 380.

In an embodiment, the elastic member 385 may deform based on an air pressure change in the auxiliary flow channel 380. For example, the elastic member 385 may deform depending on the air pressure change in the auxiliary flow channel 380. Alternatively, the elastic member 385 may expand or contract depending on the air pressure change in the auxiliary flow channel 380. Accordingly, the elastic member 385 may selectively open and close the air flow channel 370.

For example, when the aerosol generating device 300 is not in use or when a user does not inhale air through the intake 332, the elastic member 385 may be in a pre-deformation state (or an expanded state). The elastic member 385 before deformation may be disposed to block the air flow channel 370, thereby blocking the flow of a fluid in the air flow channel 370.

For example, when the user inhales air through the aerosol generating device, an intake 325 and the aerosol flow channel 324 may have relatively decreased pressure and may be in a low-pressure state. When the aerosol flow channel 324 is in a low-pressure state, the pressure in the auxiliary flow channel 380 communicating with the aerosol flow channel 324 may be lowered. The elastic member 385 may deform (or contract) when the air pressure in the auxiliary path 380 decreases. The elastic member 385 in a deformed state may open the air flow channel 370, so the air flow channel 370 may temporarily supply external air to the reservoir 322.

In an embodiment, the elastic member 385 may be formed of an elastomer such as rubber, silicone, or TPU. Additionally, the elastic member 385 may be formed of a water-repellent material.

In an embodiment of the present disclosure, the elastic member 385 may deform in response to the air pressure change in the aerosol flow channel 324 and the auxiliary flow channel 380 and may selectively open and close the air flow channel 370. The auxiliary flow channel 380 and the elastic member 385 may selectively open the air flow channel 370 only in a situation in which the aerosol generating device 300 is in use. The air flow channel 370 may be closed when the user does not inhale through the aerosol generating device 300, thereby preventing leakage of an aerosol generating material inside the reservoir 322. The air flow channel 370 may be automatically opened when the user inhales through the aerosol generating device 300, thereby supplying air into the reservoir 322 and preventing a decrease in pressure in the reservoir 322.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents. Therefore, other implementations, other embodiments, and equivalents of the claims are within the scope of the following claims.

1. An aerosol generating device comprising:
a reservoir configured to store an aerosol generating material;
a wick configured to receive the aerosol generating material from the reservoir;
a vibrator configured to atomize the aerosol generating material by vibrating the wick;
an aerosol flow channel through which an aerosol generated in the vibrator flows;
a mouthpiece comprising an intake selectively interoperating with the aerosol flow channel and driven by hinge motion based on a hinge axis; and
an air flow channel that is opened from an inside of the reservoir in a direction facing the mouthpiece and opened and closed by hinge-driven motion of the mouthpiece.

2. The aerosol generating device of claim 1, wherein the mouthpiece is driven by hinge motion between a first position at which the aerosol flow channel is disconnected from the intake and a second position at which the aerosol flow channel communicates with the intake.

3. The aerosol generating device of claim 2, wherein the mouthpiece is configured to close the air flow channel at the first position and open the air flow channel at the second position.

4. The aerosol generating device of claim 2, further comprising:
a sealing member configured to seal the air flow channel in a state in which the mouthpiece is in the first position.

5. The aerosol generating device of claim 4, wherein the sealing member is inserted into an inside of the air flow channel in a state in which the mouthpiece is in the first position.

6. The aerosol generating device of claim 4, wherein the sealing member is formed of an elastomer such as rubber, silicone, or thermoplastic polyurethane (TPU).

7. The aerosol generating device of claim 1, further comprising:
an auxiliary flow channel, wherein one side of the auxiliary flow channel is opened toward the air flow channel and another side that is opposite to the one side communicates with the aerosol flow channel.

8. The aerosol generating device of claim 7, further comprising:
an elastic member disposed to enclose the one side of the auxiliary flow channel inside the air flow channel and deforming based on an air pressure change in the auxiliary flow channel.

9. The aerosol generating device of claim 8, wherein the elastic member deforms when air pressure in the auxiliary flow channel is lowered and is configured to open the air flow channel.

10. The aerosol generating device of claim 8, wherein the elastic member is formed of an elastomer such as rubber, silicone, or thermoplastic polyurethane (TPU).

11. The aerosol generating device of claim 8, further comprising:
a leakage prevention member provided inside the air flow channel, wherein at least a partial area of the leakage prevention member is spaced apart from the elastic member when the elastic member deforms as air pressure in the auxiliary flow channel is lowered.

12. The aerosol generating device of claim 1, wherein the reservoir further comprises a valve configured to open and close the air flow channel.

13. The aerosol generating device of claim 12, further comprising a processor configured to control driving of the vibrator and the valve.

14. The aerosol generating device of claim 13, wherein the processor is configured to open the valve when the driving of the vibrator is initiated.

15. The aerosol generating device of claim 13, wherein the processor is configured to open the valve when the hinge-driven motion of the mouthpiece is detected.
